(19) United States
(12) Patent Application Publication
(10) Pub. No.: US 2025/0039418 A1
(43) Pub. Date: Jan. 30, 2025

(54) ENHANCEMENT DECODING IMPLEMENTATION AND METHOD

(71) Applicant: V-NOVA INTERNATIONAL LIMITED, London (GB)

(72) Inventors: Richard CLUCAS, London (GB); Colin MIDDLETON, London (GB); Gawain EDWARDS, London (GB); Andy DEAN, London (GB)

(21) Appl. No.: 18/704,388

(22) PCT Filed: Oct. 25, 2022
(86) PCT No.: PCT/GB2022/052720

§ 371 Date: Apr. 24, 2024

(30) Foreign Application Priority Data
Oct. 25, 2021 (GB) 2115342.4

(51) Int. Cl. H04N 19/44; H04N 19/33

(52) U.S. Cl. CPC H04N 19/44; H04N 19/33

(57) ABSTRACT

There may be provided a module for use in a video decoder, configured to: receive a base decoded video signal from a base decoding layer; receive one or more layers of correction data; and, combine the correction data with the base decoded video signal to modify the base decoded video signal such that, when one or more layers of positive residual data are combined with the modified base decoded video signal to generate enhanced video data, the enhanced data corresponds to a combination of the base decoded video signal with one or more layers of residual data from the enhancement decoding layer, wherein the positive residual data comprises only values greater than or equal to zero and is based on one or more layers of residual data from an enhancement decoding layer, the one or more layers of residual data being generated based on a comparison of data derived from a decoded video signal and data derived from an original input video signal. Further modules, methods and computer readable mediums may also be provided.

### BACKGROUND

A hybrid backward-compatible coding technology has been previously proposed, for example in WO 2013/171173, WO 2014/170819, WO 2019/141987, and WO 2018/046940, the contents of which are incorporated herein by reference. Further examples of tier-based coding formats include ISO/IEC MPEG-5 Part 2 LCEVC (hereafter ‘LCEVC’). LCEVC has been described in WO 2020/188273A1, GB 2018723.3, WO 2020/188242, and the associated standard specification documents including the Draft Text of ISO/IEC DIS 23094-2 Low Complexity Enhancement Video Coding published at MPEG 129 meeting in Brussels, held Monday, 13 Jan. 2020 to Friday, 17 Jan. 2020, all of these documents being incorporated by reference herein in their entirety.

In these coding formats a signal is decomposed in multiple “echelons” (also known as “hierarchical tiers”) of data, each corresponding to a “Level of Quality”, from the highest echelon at the sampling rate of the original signal to a lowest echelon. The lowest echelon is typically a low quality rendition of the original signal and other echelons contain information on correction to apply to a reconstructed rendition in order to produce the final output.

LCEVC adopts this multi-layer approach where any base codec (for example Advanced Video Coding—AVC, also known as H.264, or High Efficiency Video Coding—HEVC, also known as H.265) can be enhanced via an additional low bitrate stream. LCEVC is defined by two component streams, a base stream typically decodable by a hardware decoder and an enhancement stream consisting of one or more enhancement layers suitable for software processing implementation with sustainable power consumption.

In the specific LCEVC example of these tiered formats, the process works by encoding a lower resolution version of a source image using any existing codec (the base codec) and the difference between the reconstructed lower resolution image and the source using a different compression method (the enhancement). The remaining details that make up the difference with the source are efficiently and rapidly compressed with LCEVC, which uses specific tools designed to compress residual data. The LCEVC enhancement compresses residual information on at least two layers, one at the resolution of the base to correct artefacts caused by the base encoding process and one at the source resolution that adds details to reconstruct the output frames. Between the two reconstructions the picture is upscaled using either a normative up-sampler or a custom one specified by the encoder in the bitstream. In addition, LCEVC also performs some non-linear operations called residual prediction, which further improve the reconstruction process preceding residual addition, collectively producing a low-complexity smart content-adaptive (i.e., encoder driven) upscaling.

Since LCEVC and similar coding formats leverage existing decoders and are inherently backwards-compatible, there exists a need for efficient and effective integration with existing video coding implementations without complete re-design. Examples of known video coding implementations include the software tool FFmpeg, which is used by the simple media player FFplay.

Moreover, LCEVC is not limited to known codecs and is theoretically capable of leveraging yet-to-be-developed codecs. As such any LCEVC implementation should be capable of integration with any hitherto known or yet-to-be-developed codec, implemented in hardware or software, without introducing coding complexity.

LCEVC is an enhancement codec, meaning that it does not just upsample well: it will also encode the residual information necessary for true fidelity to the source and compress it (transforming, quantizing and coding it). LCEVC can also produce mathematically lossless reconstructions, meaning all of the information can be encoded and transmitted and the image perfectly reconstructed. Creator's intent, small text, logos, ads and unpredictable high-resolution details are preserved with LCEVC.

As an example:
LCEVC can deliver 2160p 10-bit HDR video over an 8-bit AVC base encoder.
When using an HEVC base encoder for a 2160p stream, LCEVC can deliver the same quality at typically 33% less of the original bitrate i.e., lower a typical bitrate of 20 Mbit/s (HEVC only) to 15 Mbit/s or lower (LCEVC on HEVC).

The many unique benefits of LCEVC can be summarised as follows. LCEVC . . .
rapidly enhances the quality and cost efficiency of all codec workflows.
reduces processing power requirements for serving a given resolution.
is deployable via software, resulting in much lower power consumption.
simplifies the transition from older generation to newer generation codecs.
improves engagement by increasing visual quality at a given bitrate.
is retrofittable and backward compatible.
is immediately deployable at scale via software update.
has low battery consumption on user devices.
reduces new codecs complexity and makes them readily deployable.

With a view to all of the above, LCEVC allows for some interesting and highly economic ways to utilise legacy devices/platforms for higher resolutions and frame rates without the need to swap the entire hardware, ignoring customers with legacy devices, or creating duplicate services for new devices. That way the introduction of higher quality video services on legacy platforms at the same time generates demand for devices with even better coding performance. In addition, LCEVC not only eliminates the need to upgrade the platform, but it also allows for delivery of higher resolution content over existing delivery networks that might have limited bandwidth capability.

The approach of LCEVC being a codec agnostic enhancer based on a software-driven implementation, which leverages available hardware acceleration, also shows in the wider variety of implementation options on the decoding side. While existing decoders are typically implemented in hardware at the bottom of the stack, LCEVC basically allows for implementation on a variety of levels i.e., from Scripting and Application to the OS and Driver level and all the way to the SoC and ASIC. In other words, there is more than one solution to implement LCEVC on the decoder side. Generally speaking, the lower in the stack the implementation takes place, the more device specific the approach becomes. Except for an implementation on ASIC level, no new hardware is needed.

Challenges exist when attempting to integrate LCEVC decoding into video decoder chipsets without re-designing those chipsets. It is desirable, at least in the short term, to implement LCEVC in a simple manner using existing architectures and designs. There are particular implementation challenges in relation to secure decoding of protected (e.g. premium) content.

In general, one place to perform operations for the LCEVC reconstruction stage, i.e. the combination of the residuals of the decoded enhancement and the base decoded video, is in the video output path. This is because the video output path is the most secure but also because such use is memory efficient, involving direct operations being performed on secure memory.

However, such an implementation in the video output path involves dealing with inherent hardware limitations. These hardware limitations include for example low memory bandwidth and limitations on the type of operations that can be performed. Elements of the video output path such as the video shifter (alternatively referred to as the graphics feeder) are specifically designed for, and excel, at functions such as overlay and colour space conversion but are limited for wider use.

Different blocks of the video output path have different limitations and trade-offs and different blocks from different manufacturers have different functionalities. For example, a hardware upscaler designed for that specific use might have different trade-offs to a video shifter. Identifying how to implement LCEVC reconstruction within the video output path involves compromises. These challenges are exacerbated when dealing with operations at UHD resolutions.

Alternative implementation of LCEVC reconstruction into the decoder CPU may be insecure as the CPU is not a protected pipeline, while implementations of LCEVC into the video output path are potentially limited by those inherent hardware limitations of the blocks of the path. Implementations thus have the potential to be inefficient.

Innovations are sought which address the limitations of video decoder chipsets and facilitate the introduction and implementation of enhancement decoders, such as LCEVC, into the wider video decoder ecosystems.

### SUMMARY OF THE INVENTION

According to a first aspect of the invention there may be provided a module for use in a video decoder, configured to: receive one or more layers of residual data from an enhancement decoding layer, the one or more layers of residual data being generated based on a comparison of data derived from a decoded video signal and data derived from an original input video signal; process the one or more layers of residual data to generate a set of modified residuals comprising one or more layers of positive residual data, wherein the positive residual data comprises only values greater than or equal to zero; generate one or more layers of correction data, the correction data being configured to combine with a base decoded video signal from a base decoding layer to modify the base decoded video signal such that, when the one or more layers of positive residual data are combined with the modified base decoded video signal to generate enhanced video data, the enhanced video data corresponds to a combination of the base decoded video signal with the one or more layers of residual data from the enhancement decoding layer.

The separation of the one or more layers of residual data into two component parts (or the direct production of the two component parts) allows for certain hardware limitations of video decoder chipsets to be overcome while still achieving the benefits of enhancement coding. The separation allows for flexibility of implementation in video decoder chipsets.

Optionally the correction data may comprise unsigned values or values greater than or equal to zero. Where certain hardware elements may not be able to perform operations on signed values for example, the correction data allows the negative components (i.e. the negative direction) of the one or more layers of residual data to be factored into the reconstruction using operations with unsigned or positive values only.

By positive residual data, we don't necessarily mean the positive component of the one or more layers of residual data, rather we mean the residual data is modified to comprise only positive values. The negative values in the data may be modified to be a value greater than or equal to zero, or ultimately removed. Those positive values of the one or more layers of residual data may be unmodified or may be modified along with the negative values of the one or more layers of residual data. The correction data may be thought of as negative residuals, or downsampled negative residuals, in a similar way.

The module may be thought of as a residual splitter, residual separator or residual rectifier in that the module generates two sets of data from the residual data, one representing the residual data using only positive values and one representing the corrections needed to restore the intentions of the original residual data. In effect, functionally, the two sets of data, i.e. the positive residual data and the correction data, can be thought of as the replacement of one set of signed data with two sets of unsigned data, replicating the effect of the signed data on another set of data.

The aspects of the invention described herein may have particular utility irrespective of the hardware on which the methods are implemented.

Each element of the correction data may correspond to a plurality of elements of the residual data. Further, dimensions of the one or more layers of correction data correspond to dimensions of a downsampled version of the one or more layers of residual data.

Since the negative residuals are downsampled, the corrected data can be applied to the base decoded signal at a lower resolution, for example, the resolution of the base decoded signal. Where operations may be compromised by hardware limitations, such as memory bandwidth, operations to apply the negative component of the one or more layers of residuals can be performed at the lower resolution before the later application of the positive residuals. In this embodiment, the correction data may be signed or unsigned and may be positive, negative or zero while still achieving the benefits of overcoming certain hardware limitations.

In preferred embodiments, the positive residual data is generated using the correction data and the one or more layers of residual data. Additionally or alternatively, elements of the correction data are calculated as a function of a plurality of elements of the residual data.

In a certain embodiment, elements of the correction data are calculated according to: n=−f(a, b, c, d); where n is an element of the correction data and a, b, c, d are elements of the residual data, wherein elements of the positive residual data a′, b′, c′, d′ are calculated according to: a′=a+n; b′=b+n; c′=c+n; d′=d+n; and wherein elements a′, b′, c′, d′ of the positive residual data each correspond to elements a, b, c, d of the residual data respectively, preferably n=−min(a, b, c, d). As noted, preferably the correction data is unsigned or positive. In this embodiment each value of the correction data corresponds to four values of the original residual data. Alternatively, n=f(a, b, c, d). In a further embodiment positive residuals=signed residuals+upscaled correction data.

The module may be a module in a CPU or GPU of a video decoder chipset. The module may perform operations on clear memory, that is, normal general purpose memory. The creation of the positive residual data and correction data can be performed in a non-protected pipeline, utilising the computational benefits of that pipeline.

According to a second aspect of the invention there may be provided a module for use in a video decoder, configured to: receive a base decoded video signal from a base decoding layer; receive one or more layers of correction data; and, combine the correction data with the base decoded video signal to modify the base decoded video signal such that, when one or more layers of positive residual data are combined with the modified base decoded video signal to generate enhanced video data, the enhanced data corresponds to a combination of the base decoded video signal with one or more layers of residual data from the enhancement decoding layer, wherein the positive residual data comprises only values greater than or equal to zero and is based on one or more layers of residual data from an enhancement decoding layer, the one or more layers of residual data being generated based on a comparison of data derived from a decoded video signal and data derived from an original input video signal.

By combining the correction data with the base decoded video signal in this way, the operation can be performed at a part of a video decoder that can perform the operation efficiently and can be separated from the operations of any reconstruction or separation stages that might be better suited to be performed at other elements of the video decoder.

In this aspect of the invention, the invention is not specific to how the positive residual data and the correction data is formed, rather the aspects invention may be concerned with their use and their subsequent implementation so that the original image can be reconstructed using the two sets of residuals as the enhancement data and the base decoded data.

Aspects of the invention overcome particular challenges where elements of a video decoder implementing an LCEVC reconstruction stage are unable to perform signed addition and/or subtraction. The invention obviates the need to perform signed addition in the video pipeline.

The module may be a subtraction module configured to subtract the one or more layers of correction data from the base decoded video signal to generate the modified decoded video signal. Thus the element of the video decoder performing the combination operation may be able to perform a subtraction operation where the element performing the reconstruction stage may not. Similarly, the subtraction operation may be performed at an element of the decoder that may only be able to efficiently perform operations at the level of resolution of the base decoded video signal. Separating the operations in this way provides for flexibility of implementation within a video decoder.

The module may be a module in a hardware block or GPU of a video decoder chipset. Where subtraction or signed addition may not be able to be performed in the video shifter or video pipeline, the correction data can be applied at an element of the video decoder that is well suited to perform the operations, while the video pipeline can be used for other operations such as a subsequent reconstruction stage.

Optionally the subtraction module is comprised in a secure region of a video decoder chipset and operations are performed on secure memory of the video decoder chipset. In this way the combination of the correction data and the base decoded layer can be performed in the secure pipeline such that secure video content may not be compromised. In alternative implementations, all operations described herein may be performed entirely in clear, normal general purpose memory.

According to a third aspect of the invention there may be provided a video decoder comprising the module of the first aspect and/or any of the second aspect.

Operations of the invention may be performed within the video pipeline or may be performed writing back to memory.

The video decoder may further comprise a reconstruction module configured to combine the modified base decoded video signal with the one or more layers of positive residual data. The reconstruction module may be configured to generate enhanced video data. Thus the positive residual data, when combined with the modified base decoded video signal, can reconstruct the original image including the negative values separated into the correction data.

The reconstruction module may comprise an upscaler configured to upscale the modified base decoded video signal before the combination. The combination may thus be performed at a first resolution of the positive residual values while the subtraction may be performed at a second resolution, lower than the first resolution. The different operations can therefore be performed at hardware elements suitable to perform the operations efficiently, allowing flexibility in implementation. Where the positive residual data and correction data is at the same, first resolution, then the step of upscaling may not be necessary and the correction data may be combined with the base decoded video signal prior to the combination of the positive residual data with the modified base decoded video signal, all at the first resolution.

In an optional implementation, the upscaler may be a hardware upscaler operating on secure memory. Thus the upscaling may be performed using an element specifically designed for the purpose, providing efficiency of design.

Each of the combining steps described herein may comprise a step of uscaling or upsampling. For example, the combining of the decoded base decoded signal with the correction data may comprise the step of upsampling the correction data and/or base decoded signal before or after combination or addition. Similarly, the combining of the positive residual data with the modified base decoded signal may comprise the step of upsampling the positive residual data and/or modified base decoded signal before or after combination or addition. In short, the combination may be performed at any resolution, i.e. the first resolution of the base video or the second resolution of the residual data. Typically the second resolution is higher than the first resolution.

In certain embodiments, the reconstruction module is a module in a hardware block, GPU or video output path of a video decoder chipset. Preferably, the reconstruction module is a module of a video shifter.

In this way, the video output path (‘video pipeline’) may be used for as many operations as possible and a hardware block, CPU or GPU for any remaining operations. The operations can be divided so that the reconstruction operations can be performed at a video shifter or in the video pipeline, which is well suited to such operations, but may be unable to perform either subtraction and/or signed addition. The video shifter is a protected pipeline in that it may operate on secure memory and thus is suitable for secure content and the reconstruction of secure video.

The video decoder may further comprise the base decoding layer, wherein the base decoding layer comprises a base decoder configured to receive a base encoded video signal and output the base decoded video signal. The video decoder may further comprise an enhancement decoder to implement the enhancement decoding layer, the enhancement decoder being configured to: receive an encoded enhancement signal; and, decode the encoded enhancement signal to obtain the one or more layers of residual data. The one or more layers of residual data may be generated based on a comparison of data derived from a decoded video signal and data derived from an original input video signal.

The enhancement decoding layer is most preferably compliant with the LCEVC standard.

As noted, benefits of the concepts may be realised through two complementary, yet both optional, features: (a) splitting the residuals into ‘positive’ and ‘negative’ residuals, referred to here as positive residuals and correction data; and (b) the alteration of the enhancement reconstruction operations to account for hardware limitations such as low bandwidth and the inability for the video pipeline to subtract and handle negative values, for example in signed addition operations.

In certain embodiments the module may be further configured to apply a dither plane, wherein the dither plane is input at a first resolution, the first resolution being lower than a resolution of the enhanced video data. The dither plane may be a separate plane. The dither plane may also be applied to two or more YUV planes. Applying a dither plane in this way yields surprisingly good visual quality.

According to a fourth aspect of the invention there may be provided a method for use in a video decoder, comprising: receiving one or more layers of residual data from an enhancement decoding layer, the one or more layers of residual data being generated based on a comparison of data derived from a decoded video signal and data derived from an original input video signal; processing the one or more layers of residual data to generate a set of modified residuals comprising one or more layers of positive residual data, wherein the positive residual data comprises only values greater than or equal to zero; generating one or more layers of correction data, the correction data being configured to combine with a base decoded video signal from a base decoding layer to modify the decoded video signal such that, when the one or more layers of positive residual data are combined with the modified base decoded video signal to generate enhanced video data, the enhanced video data corresponds to a combination of the base decoded video signal with the one or more layers of residual data from the enhancement decoding layer.

The positive residual data may be generated using the correction data and the one or more layers of residual data. Elements of the correction data may be calculated as a function of a plurality of elements of the residual data. Elements of the correction data may be calculated according to: n=−f(a, b, c, d); where n is an element of the correction data and a, b, c, d are elements of the residual data, wherein elements of the positive residual data a′, b′, c′, d′ are calculated according to: a′=a+n; b′=b+n; c′=c+n; d′=d+n; and wherein elements a′, b′, c′, d′ of the positive residual data each correspond to elements a, b, c, d of the residual data respectively, preferably n=−min(a, b, c, d).

According to a fifth aspect of the invention there may be provided a method for use in a video decoder, comprising: receiving a base decoded video signal from a base decoding layer; receiving one or more layers of correction data; and, combining the correction data with the base decoded video signal to modify the decoded video signal such that, when one or more layers of positive residual data are combined with the modified base decoded video signal to generate enhanced video data, the enhanced data corresponds to a combination of the base decoded video signal with one or more layers of residual data from the enhancement decoding layer, wherein the positive residual data comprises only values greater than or equal to zero and is based on one or more layers of residual data from an enhancement decoding layer, the one or more layers of residual data being generated based on a comparison of data derived from a decoded video signal and data derived from an original input video signal.

The step of combining may comprise subtracting the one or more layers of correction data from the base decoded video signal to generate the modified decoded video signal. The one or more layers of correction data may generated according to the method of the above fourth aspect of the invention.

The method may further comprise: upsampling the modified base decoded video signal; and, combining the upsampled modified base decoded video signal with the one or more layers of positive residual data to generate a decoded reconstruction of an original input video signal, preferably the step of combining the upsampled modified base decoded video signal with the one or more layers of positive residual data is performed by a hardware block, GPU or video output path of a video decoder chipset.

The method may further comprise applying a dither plane, wherein the dither plane is input at a first resolution, the first resolution being lower than a resolution of the enhanced video data.

According to a further aspect there may be provide a non-transitory computer readable medium comprising computer program code configured to cause a processor to implement the method of any of the above aspects.

### BRIEF DESCRIPTION OF DRAWINGS

Examples of systems and methods in accordance with the invention will now be described with reference to the accompanying drawings, in which:

FIG. 1 shows a known, high-level schematic of an LCEVC decoding process;

FIGS. 2a and 2b respectively show a schematic of a comparative base decoder and a schematic of a decoder integration layer in a video pipeline;

FIG. 3 illustrates a known, high-level schematic of a video decoder chipset;

FIG. 4 illustrates a schematic of a video decoder according to examples of the present disclosure;

FIG. 5 illustrates a schematic of a video decoder according to examples of the present disclosure;

FIG. 6A illustrates positive and negative residuals according to examples of the present disclosure;

FIG. 6B illustrates a worked example of positive and negative residuals according to examples of the present disclosure;

FIG. 7A illustrates a flow diagram of a method of generating positive and negative residuals according to examples of the present disclosure;

FIG. 7B illustrates a flow diagram of a method of generating a modified base decoded video signal according to examples of the present disclosure;

FIG. 7C illustrates a flow diagram of a method of reconstructing an original input video signal according to examples of the present disclosure;

FIG. 8 illustrates a high-level schematic of a video decoder chipset according to examples of the present disclosure;

FIG. 9 illustrates a high-level schematic of a video decoder chipset according to examples of the present disclosure;

FIG. 10 illustrates a block diagram of integration of an enhancement decoder according to examples of the present disclosure;

FIG. 11 illustrates a first video display path according to examples of the present disclosure;

FIG. 12 illustrates a second video display path according to examples of the present disclosure; and,

FIG. 13 illustrates a third video display path according to examples of the present disclosure.

### DETAILED DESCRIPTION

This disclosure describes an implementation for integration of a hybrid backward-compatible coding technology with existing decoders, optionally via a software update. In a non-limiting example, the disclosure relates to an implementation and integration of MPEG-5 Part 2 Low Complexity Enhancement Video Coding (LCEVC). LCEVC is a hybrid backward-compatible coding technology which is a flexible, adaptable, highly efficient and computationally inexpensive coding format combining a different video coding format, a base codec (i.e. an encoder-decoder pair such as AVC/H.264, HEVC/H.265, or any other present or future codec, as well as non-standard algorithms such as VP9, AV1 and others) with one or more enhancement levels of coded data.

Example hybrid backward-compatible coding technologies use a downsampled source signal encoded using a base codec to form a base stream. An enhancement stream is formed using an encoded set of residuals which correct or enhance the base stream for example by increasing resolution or by increasing frame rate. There may be multiple levels of enhancement data in a hierarchical structure. In certain arrangements, the base stream may be decoded by a hardware decoder while the enhancement stream may be suitable for being processed using a software implementation. Thus, streams are considered to be a base stream and one or more enhancement streams, where there are typically two enhancement streams possible but often one enhancement stream used. It is worth noting that typically the base stream may be decodable by a hardware decoder while the enhancement stream(s) may be suitable for software processing implementation with suitable power consumption. Streams can also be considered as layers.

The video frame is encoded hierarchically as opposed to using block-based approaches as done in the MPEG family of algorithms. Hierarchically encoding a frame includes generating residuals for the full frame, and then a reduced or decimated frame and so on. In the examples described herein, residuals may be considered to be errors or differences at a particular level of quality or resolution.

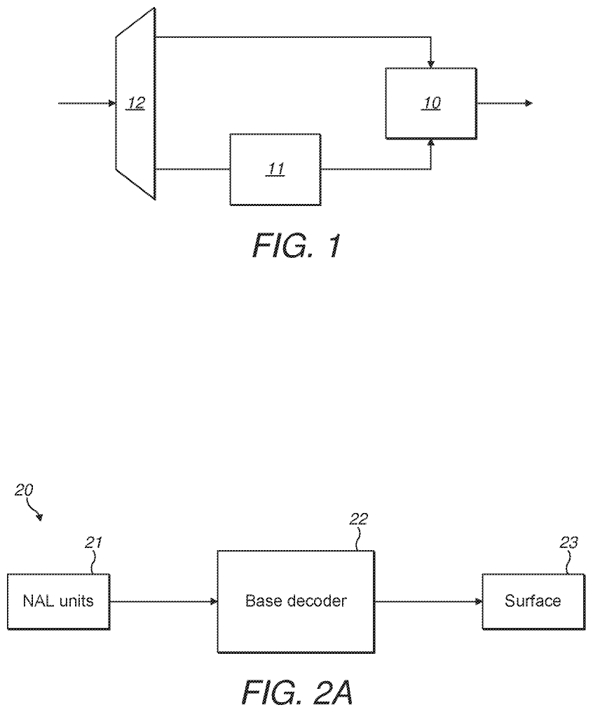

For context purposes only, as the detailed structure of LCEVC is known and set out in the approved draft standards specification, FIG. 1 illustrates, in a logical flow, how LCEVC operates on the decoding side assuming H.264 as the base codec. Those skilled in the art will understand how the examples described herein are also applicable to other multi-layer coding schemes (e.g., those that use a base layer and an enhancement layer) based on the general description of LCEVC that is presented with reference to FIG. 1. Turning to FIG. 1, the LCEVC decoder 10 works at individual video frame level. It takes as an input a decoded low-resolution picture from a base (H.264 or other) video decoder 11 and the LCEVC enhancement data to produce a decoded full-resolution picture ready for rendering on the display view. The LCEVC enhancement data is typically received either in Supplemental Enhancement Information (SEI) of the H.264 Network Abstraction Layer (NAL), or in an additional data Packet Identifier (PID) and is separated from the base encoded video by a demultiplexer 12. Hence, the base video decoder 11 receives a demultiplexed encoded base stream and the LCEVC decoder 10 receives a demultiplexed encoded enhancement stream, which is decoded by the LCEVC decoder 10 to generate a set of residuals for combination with the decoded low-resolution picture from the base video decoder 11.

LCEVC can be rapidly implemented in existing decoders with a software update and is inherently backwards-compatible since devices that have not yet been updated to decode LCEVC are able to play the video using the underlying base codec, which further simplifies deployment.

In this context, there is proposed herein a decoder implementation to integrate decoding and rendering with existing systems and devices that perform base decoding. The integration is easy to deploy. It also enables the support of a broad range of encoding and player vendors, and can be updated easily to support future systems. Embodiments of the invention specifically relate to how to implement LCEVC in such a way as to provide for decoding of protected content in a secure manner.

The proposed decoder implementation may be provided through an optimised software library for decoding MPEG-5 LCEVC enhanced streams, providing a simple yet powerful control interface or API. This allows developers flexibility and the ability to deploy LCEVC at any level of a software stack, e.g. from low-level command-line tools to integrations with commonly used open-source encoders and players. In particular, embodiments of the present invention generally relate to a driver-level implementations and a System on a chip (SoC) level implementation.

The terms LCEVC and enhancement may be used herein interchangeably, for example, the enhancement layer may comprise one or more enhancement streams, that is, the residuals data of the LCEVC enhancement data.

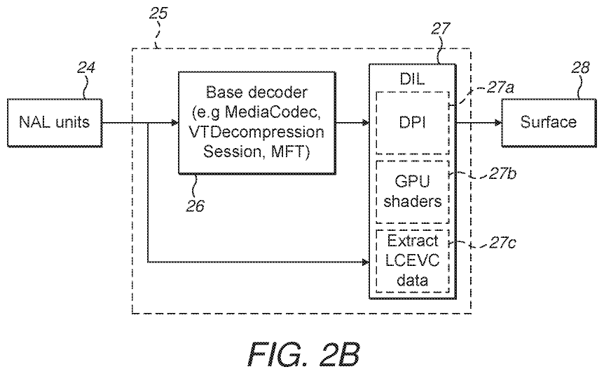

FIG. 2a illustrates an unmodified video pipeline 20. In this conceptual pipeline, obtained or received Network Abstraction Layer (NAL) units are input to a base decoder 22. The base decoder 22 may, for example, be a low-level media codec accessed using a mechanism such as MediaCodec (e.g. as found in the Android (RTM) operating system), VTDecompression Session (e.g. as found in the iOS (RTM) operating system) or Media Foundation Transforms (MFT—e.g. as found in the Windows (RTM) family of operating systems), depending on the operating system. The output of the pipeline is a surface 23 representing the decoded original video signal (e.g. a frame of such a video signal, where sequential display of success frames renders the video).

FIG. 2b illustrates a proposed video pipeline using an LCEVC decoder integration layer, conceptually. Like the comparative video decoder pipeline of FIG. 2a, NAL units 24 are obtained or received and are processed by an LCEVC decoder 25 to provide a surface 28 of reconstructed video data. Through the use of the LCEVC decoder 25, the surface 28 may be higher quality than the comparative surface 23 in FIG. 2a or the surface 28 may be at the same quality as the comparative surface 23 but require fewer processing and/or network resources.

In FIG. 2b, the LCEVC decoder 25 is implemented in conjunction with a base decoder 26. The base decoder 26 may be provided by a variety of mechanisms, including by an operating system function as discussed above (e.g. may use a MediaCodec, VTDecompression Session or MFT interface or command). The base decoder 26 may be hardware accelerated, e.g. using dedicated processing chips to implement operations for a particular codec. The base decoder 26 may be the same base decoder that is shown as 22 in FIG. 2a and that is used for other non-LCEVC video decoding, e.g. may comprise a pre-existing base decoder.

In FIG. 2b, the LCEVC decoder 25 is implemented using a decoder integration layer (DIL) 27. The decoder integration layer 27 acts to provide a control interface for the LCEVC decoder 25, such that a client application may use the LCEVC decoder 25 in a similar manner to the base decoder 22 shown in FIG. 2a, e.g. as a complete solution from buffer to output. The decoder integration layer 27 functions to control operation of a decoder plug-in (DPI) 27a and an enhancement decoder 27b to generate a decoded reconstruction of an original input video signal. In certain variations, as shown in FIG. 2b, the decoder integration layer may also control GPU functions 27c such as GPU shaders to reconstruct the original input video signal from the decoded base stream and the decoded enhancement stream.

NAL units 24 comprising the encoded video signal together with associated enhancement data may be provided in one or more input buffers. The input buffers may be fed (or made available) to the base decoder 26 and to the decoder integration layer 27, in particular the enhancement decoder that is controlled by the decoder integration layer 27. In certain examples, the encoded video signal may comprise an encoded base stream and be received separately from an encoded enhancement stream comprising the enhancement data, in other preferred examples, the encoded video signal comprising the encoded base stream may be received together with the encoded enhancement stream, e.g. as a single multiplexed encoded video stream. In the latter case, the same buffers may be fed (or made available) to both the base decoder 26 and to the decoder integration layer 27. In this case, the base decoder 26 may retrieve the encoded video signal comprising the encoded base stream and ignore any enhancement data in the NAL units. For example, the enhancement data may be carried in SEI messages for a base stream of video data, which may be ignored by the base decoder 26 if it is not adapted to process custom SEI message data. In this case, the base decoder 26 may operate as per the base decoder 22 in FIG. 2a, although in certain cases, the base video stream may be at a lower resolution that comparative cases.

On receipt of the encoded video signal comprising the encoded base stream, the base decoder 26 is configured to decode and output the encoded video signal as one or more base decoded frames. This output may then be received or accessed by the decoder integration layer 27 for enhancement. In one set of examples, the base decoded frames are passed as inputs to the decoder integration layer 27 in presentation order.

The decoder integration layer 27 extracts the LCEVC enhancement data from the input buffers and decodes the enhancement data. Decoding of the enhancement data is performed by the enhancement decoder 27b, which receives the enhancement data from the input buffers as an encoded enhancement signal and extracts residual data by applying an enhancement decoding pipeline to one or more streams of encoded residual data. For example, the enhancement decoder 27b may implement an LCEVC standard decoder as set out in the LCEVC specification.

A decoder plug-in is provided at the decoder integration layer to control the functions of the base decoder. In certain cases, the decoder plug-in 27a may handle receipt and/or access of the base decoded video frames and apply the LCEVC enhancement to these frames, preferably during playback. In other cases, the decoder plug-in may arrange for the output of the base decoder 26 to be accessible to the decoder integration layer 27, which is then arranged to control addition of a residual output from the enhancement decoder to generate the output surface 28. Once integrated in a decoding device, the LCEVC decoder 25 enables decoding and playback of video encoded with LCEVC enhancement. Rendering of a decoded, reconstructed video signal may be supported by one or more GPU functions 27c such as GPU shaders that are controlled by the decoder integration layer 27.

In general, the decoder integration layer 27 controls operation of the one or more decoder plug-ins and the enhancement decoder to generate a decoded reconstruction of the original input video signal 28 using a decoded video signal from the base encoding layer (i.e. as implemented by the base decoder 26) and the one or more layers of residual data from the enhancement encoding layer (i.e. as implemented by the enhancement decoder). The decoder integration layer 27 provides a control interface, e.g. to applications within a client device, for the video decoder 25.

Depending on configuration, the decoder integration layer may output the surface 28 of decoded data in different ways. For example, as a buffer, as an off-screen texture or as an on-screen surface. Which output format to use may be set in configuration settings that are provided upon creation of an instance of the decoding integration layer 27, as further explained below.

In certain implementations, where no enhancement data is found in the input buffers, e.g. where the NAL units 24 do not contain enhancement data, the decoder integration layer 27 may fall back to passing through the video signal at the lower resolution to the output, that is, the output of the base decoding layer as implemented by the base decoder 26. In this case, the LCEVC decoder 25 may operate as per the video decoder pipeline 20 in FIG. 2a.

The decoder integration layer 27 can be used for both application integration and operating system integration, e.g. for use by both client applications and operating systems. The decoder integration layer 27 may be used to control operating system functions, such as function calls to hardware accelerated base codecs, without the need for a client application to have knowledge of these functions. In certain cases, a plurality of decoder plug-ins may be provided, where each decoder plug-in provides a wrapper for a different base codec. It is also possible for a common base codec to have multiple decoder plug-ins. This may be the case where there are different implementations of a base codec, such as a GPU accelerated version, a native hardware accelerated version and an open-source software version.

When viewing the schematic diagram of FIG. 2b, the decoder plug-ins may be considered integrated with the base decoder 26 or alternatively a wrapper around that base decoder 26. Effectively FIG. 2b can be thought of as a stacked visualisation. The decoder integration layer 27 in FIG. 2b, conceptually includes functionality to extract the enhancement data from the NAL units 27b, functionality 27a to communicate with the decoder plug-ins and apply enhancement decoded data to base decoded data and one or more GPU functions 27c.

The set of decoder plug-ins are configured to present a common interface (i.e. a common set of commands) to the decoder integration layer 27, such that the decoder integration layer 27 may operate without knowledge of the specific commands or functionality of each base decoder. The plug-ins thus allow for base codec specific commands, such as MediaCodec, VTDecompression Session or MFT, to be mapped to a set of plug-in commands that are accessible by the decoder integration layer 27 (e.g. multiple different decoding function calls may be mapped to a single common plug-in “Decode( . . . )” function).

Since the decoder integration layer 27 effectively comprises a ‘residuals engine’, i.e. a library that from the LCEVC encoded NAL units produces a set of correction planes at different levels of quality, the layer can behave as a complete decoder (i.e. the same as decoder 22) through control of the base decoder.

For simplicity, we will refer to the instructing entity here as the client but it will be understood that the client may be considered to be any application layer or functional layer and that the decoder integration layer 27 may be integrated simply and easily into a software solution. The terms client, application layer and user may be used herein interchangeably.

In an application integration, the decoder integration layer 27 may be configured to render directly to an on-screen surface, provided by a client, of arbitrary size (generally different from the content resolution). For example, even though a base decoded video may be Standard Definition (SD), the decoder integration layer 27, using the enhancement data, may render surfaces at High Definition (HD), Ultra High Definition (UHD) or a custom resolution. Further details of out-of-standard methods of upscaling and post-processing that may be applied to a LCEVC decoded video stream are found in PCT/GB2020/052420, the contents of which are incorporated herein by reference. Example application integrations include, for example, use of the LCEVC decoder 25 by ExoPlayer, an application level media player for Android, or VLCKit, an objective C wrapper for the IibVLC media framework. In these cases, VLCKit and/or ExoPlayer may be configured to decode LCEVC video streams by using the LCEVC decoder 25 “under the hood”, where computer program code for VLCKit and/or ExoPlayer functions is configured to use and call commands provided by the decoder integration layer 27, i.e. the control interface of the LCEVC decoder 25. A VLCKit integration may be used to provide LCEVC rendering on iOS devices and an ExoPlayer integration may be used to provide LCEVC rendering on Android devices.

In an operating system integration, the decoder integration layer 27 may be configured to decode to a buffer or draw on an off-screen texture of the same size of the content final resolution. In this case, the decoder integration layer 27 may be configured such that it does not handle the final render to a display, such as a display device. In these cases, the final rendering may be handled by the operating system, and as such the operating system may use the control interface provided by the decoder integration layer 27 to provide LCEVC decoding as part of an operating system call. In these cases, the operating system may implement additional operations around the LCEVC decoding, such as YUV to RGB conversion, and/or resizing to the destination surface prior to the final rendering on a display device. Examples of operating system integration include integration with (or behind) MFT decoder for Microsoft Windows (RTM) operating systems or with (or behind) Open Media Acceleration (OpenMAX-OMX) decoder, OMX being a C-language based set of programming interfaces (e.g. at the kernel level) for low power and embedded systems, including smartphones, digital media players, games consoles and set-top boxes.

These modes of integration may be set by a client device or application.

The configuration of FIG. 2b, and the use of a decoder integration layer, allows LCEVC decoding and rendering to be integrated with many different types of existing legacy (i.e. base) decoder implementations. For example, the configuration of FIG. 2b may be seen as a retrofit for the configuration of FIG. 2a as may be found on computing devices. Further examples of integrations include the LCEVC decoding libraries being made available within common video coding tools such as FFmpeg and FFplay. For example, FFmpeg is often used as an underlying video coding tool within client applications. By configuring the decoder integration layer as a plug-in or patch for FFmpeg, an LCEVC-enabled FFmpeg decoder may be provided, such that client applications may use the known functionalities of FFmpeg and FFplay to decode LCEVC (i.e. enhanced) video streams. For example an LCEVC-enabled FFmpeg decoder may provide video decoding operations, such as: playback, decoding to YUV and running metrics (e.g. peak signal-to-noise ratio—PSNR or Video Multimethod Assessment Fusion—VMAF—metrics) without having to first decode to YUV. This may be possible by the plug-in or patch computer program code for FFmpeg calling functions provided by the decoder integration layer.

As described above, to integrate an LCEVC decoder such as 25 into a client, i.e. an application or operating system, a decoder integration layer such as 27 provides a control interface, or API, to receive instructions and configurations and exchange information.

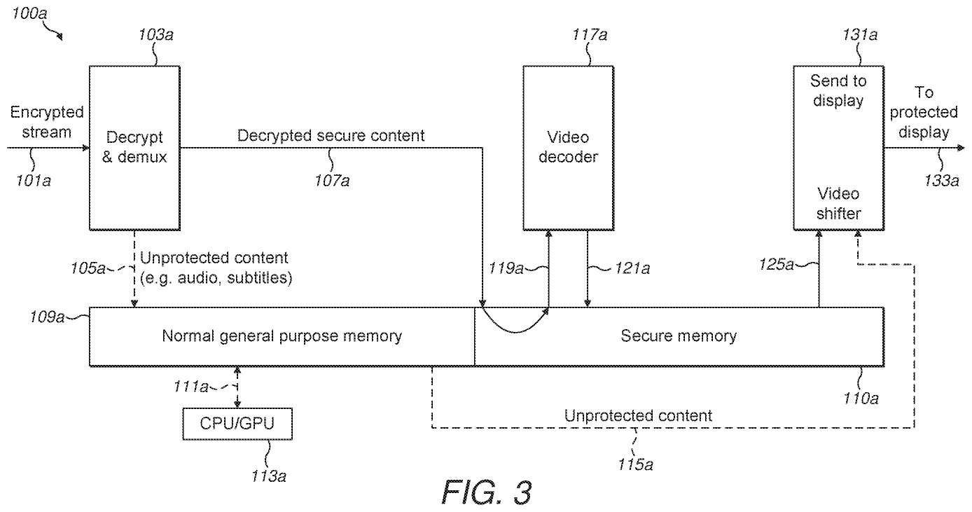

FIG. 3 illustrates a computing system 100a comprising a conventional video shifter 131a. The computing system 100a is configured to decode a video signal, where the video signal is encoded using a single codec, for example VVC, AVC or HEVC. In other words, the computing system 100a is not configured to decode a video signal encoded using a tier-based codec such as LCEVC. The computing system 100a further comprises a receiving module 103a, a video decoding module 117a, an output module 131a, an unsecure memory 109a, a secure memory 110a, and a CPU or GPU 113a. The computing system 100a is in connection with a protected display (not illustrated).

The receiving module 103a is configured to receive an encrypted stream 101a, separate the encrypted stream, and output decrypted secure content 107a (e.g. decrypted encoded video signal, encoded using a single codec) to secure memory 110a. The receiving module 103a is configured to output unprotected content 105a, such as audio or subtitles, to the unsecure memory 109a. The unprotected content may be processed 111a by the CPU or GPU 113a. The (processed) unprotected content is output 115a to the video shifter 131a.

The video decoder 117a is configured to receive 119a the decrypted secure content (e.g. decrypted encoded video signal) and decode the decrypted secure content. The decoded decrypted secure content is sent 121a to the secure memory 110a and subsequently stored in the secure memory 110a. The decoded decrypted secure content is output 125a, from the secure memory, to the video shifter 131a.

In other words, the video shifter 131a: reads the decoded decrypted secure content 125a from the secure memory; reads 115a the unsecure content, for example, subtitles from the unsecure memory 109a; combines the decoded decrypted secure content and the subtitles; and outputs the combined data 133a to a protected display.

The various components (i.e. the modules and the memory memory) are connected via a number of channels. The channels, also referred to as pipes, are communication channels that allow data to flow between the two components at each end of the channel. In general, channels connected to the secure memory 110c are secured channels. Channels connected to the unsecure memory 109c are unsecure channels.

PCT/GB2022/051238, herein incorporated by reference in its entirety, discusses various examples of implementing LCEVC reconstruction on video decoders for example, set-top boxes. The security relevant part of the tier-based (e.g. LCEVC) decoder implementation lies in the processing steps where the decoded enhancement layer is combined with the decoded (and upscaled) base layer to create the final output sequence. Depending on what level of the stack the tier based (e.g. LCEVC) decoder is being implemented, different approaches exist to establish a secure and ECP compliant content workflow.

With the base decoder utilising the Secure Memory, PCT/GB2022/051238 discuss how to combine the output from the base decoder in Secure Memory and the LCEVC decoder output in General Purpose Memory to assemble the enhanced output sequence. Two similar approaches are proposed: to provide a secure decoder when LCEVC is implemented at a driver level implementation; or to provide a secure decoder when LCEVC is implemented at a System on a Chip (SoC) level. Which approach of the two is utilised may depend on the capabilities of the chipset used in the respective decoding device.

Implementing LCEVC (or other tier-based codecs) on a device driver level utilises hardware blocks or GPU. In general, once the base layer and the (e.g. LCEVC) enhancement layer have been separated, most of the decoding of the (e.g. LCEVC) enhancement layer can take place in the CPU and hence in General Purpose (unsecure) Memory. PCT/GB2022/051238 proposes that a module (e.g. a secure hardware block or GPU) is used to up-sample the output of the base encoder using Secure Memory, combines the upsampled output with predicted residuals and applies the decoded enhancement layer (e.g. LCEVC residual map) coming from General Purpose (unsecure) Memory. Afterwards, the output sequence (e.g. an output plane) can be sent to a protected display via an output module (e.g. a Video Shifter), which is part of an output video path in the decoder (i.e. in the chipset).

In short, the LCEVC reconstruction stage, i.e. the steps of upsampling the base decoded video signal and combining that base decoded video signal with the one or more residual layers to create the reconstructed video, can be performed on aspects of the computing system which have access to secure memory.

Examples include the video output path, such as the video shifter, a hardware block such as a hardware upscaler, or GPU of the computing system. The video shifter may also be referred to as a graphics feeder.

When a module implementing the LCEVC reconstruction stage is a hardware block, the hardware block can be used to process the data very efficiently (for example by maximising page efficiency Double Data Rate, DDR, memory).

However, not all devices have hardware extra blocks, moreover, not all of these blocks can read secure memory. In such cases, it may be preferable to have the module's functionality in a GPU module (which many relevant devices have), this provides a flexible approach and can be implemented on many different devices (including phones). By writing the functionality of the module as a layer running on the GPU (e.g. using open GLES), implementations can function on a variety of different GPUs (and hence different devices), this provides a single solution to the problem (i.e. of providing secure video) that can be implemented on many devices. In this sense). This is generally in contrast with, a SoC level implementation that generally uses a device (video shifter) architecture specific implementation and therefore use a unique solution for each video shifter to, for example, call the correct functions and connecting them up.

While examples described herein are provided in the context of a secure memory, for example the implementations described in PCT/GB2022/051238, it will be understood that the principles proposed herein are not limited as such but are provided merely for context. The benefits of the invention can be realised in video decoder implementations that do not require a protected pipeline and the protected pipeline is provided merely for additional explanation.

When integrating LCEVC into existing video decoder architectures, it may be an objective to do so in the most simple and efficient manner. While it is contemplated that LCEVC can be retrofit to existing set-top boxes, it is also advantageous to integrate LCEVC into new chipsets. It might be desirable to integrate LCEVC without significant changes to the architecture so that chipset manufacturers do not need to change design but can simply rollout LCEVC decoding quickly and easily. The ease of integration is one of the many known advantages of LCEVC.

However, to implement LCEVC in this way on existing chipset designs introduces challenges.

Handling secure content is one such example, as identified above. Another example of these integration challenges is the inherent hardware limitations of the existing video decoder architectures.

In general, it may be that the most appropriate place to perform the operations of the LCEVC reconstruction stage is in the video output path of the video decoder chipset. This addresses security needs by keeping the video in the protected pipeline but it is also the most memory efficient.

Examples of hardware limitations include resources issues to handle UHD, the inability to handle ‘signed’ values, i.e. a hardware block might only handle positive values, and/or the inability to perform a subtract operation. These three example limitations introduce compromises due to the nature of the LCEVC reconstruction stage. That is, the one or more residual layers output by the enhancement decoder typically comprise ‘signed’ values (i.e. positive or negative) and the base decoded video signal must be upsampled and combined with these signed values to reconstruct the original video.

In more specific examples of hardware limitations, in certain chipsets, when video is overlayed it is only possible to perform add (because the block is performing blending). Typically with blending hardware it is possible to put the hardware in additive mode but not a signed additive mode. LCEVC relies on additions and subtractions.

In an alternative specific example of a hardware limitation, a set-top box might have limited memory bandwidth. The addition and subtraction of UHD to UHD is 4×HD. For UHD, the base video is an HD image. Thus one might be able to use a hardware block to perform addition and subtraction of HD values but when these are attempted for UHD, the hardware block either breaks or it is very inefficient (caused by a lack of memory bandwidth).

So, in an example, a hardware block such as a hardware upscaler or other similar component might be able to perform subtraction but a video shifter cannot and a video shifter might not be able to handle signed values.

Typically, processors of the video pipeline are also unable to perform the necessary operations at the UHD resolution but may be able to perform certain operations of the input is in a certain form.

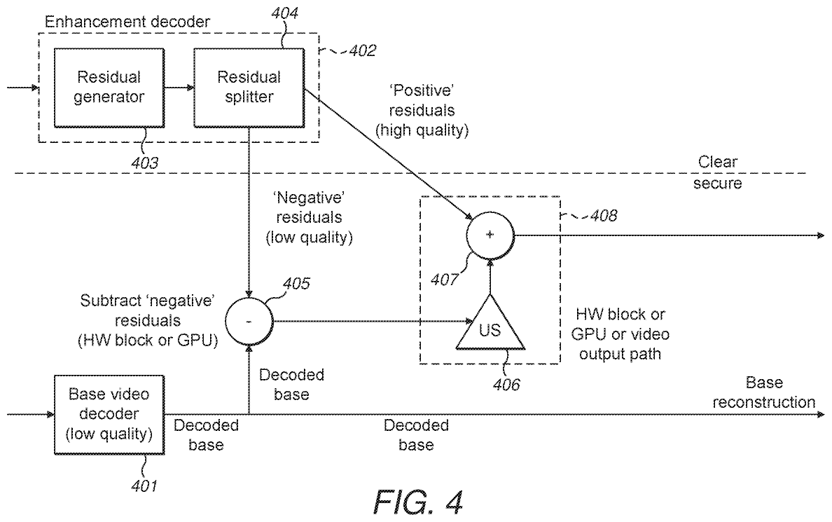

An overview of the present invention is illustrated in FIG. 4. The invention sets out to realise an implementation in which the video output path (‘video pipeline’) is used for as many operations as possible and a hardware block, CPU or GPU for any remaining operations. Guiding principles for the implementation are primarily simplicity and, secondarily, security, i.e. the ability to decode secure content.

As shown in FIG. 4, the enhancement decoder 402, such as for example an LCEVC decoder, comprises a residual generator 403. The residual generator is part of the enhancement operations and generates one or more layers of residual data. As indicated elsewhere, the residual data is a set of signed values (i.e. positive and negative) which generally correspond to the difference between a decoded version of an input video, decoded using the base codec, and the original input video signal.

A module 404 is proposed herein which ‘splits’ the residual data into a negative component and a positive component. Throughout the present disclosure, the module may be referred to as a residual splitter, residual separator or residual rectifier and these terms may be used interchangeably. Each give an idea of the module's functionality. The module functions to produce two sets of data. The first corresponds to a modified form of the residual data using only positive values. The second corresponds to set of data values which can be used to modify the base decoded signal (for example at a lower quality) such that when the base decoded signal is combined with the residual data with only positive values, the originally intended signal can be reconstructed.

In this sense when we refer to positive residuals and negative residuals, it may be understood that both may in fact be positive or unsigned values but the positive residuals comprise only positive values and the negative residuals comprise an indication of the negative component of the original residuals. The original negative residuals may still be included within the positive residuals but may have been modified to have values greater than or equal to zero. This will become clear from the worked example below.

By positive component we mean a positive direction and by negative component we mean a negative direction.

In this description we will refer to the set of residuals that have been modified so that the negative residuals are positive or zero values as the ‘positive residuals’ but it will be understood that this could equally be referred to as the ‘modified’ residuals and have a similar meaning. That is, the word ‘positive’ is simply a label.

Similarly, we will refer to the ‘negative’ residuals with the ‘negative’ label but this set of residuals can be thought of as a set of residuals which are used to modify the base decoded video prior to combination of the base decoded video with the ‘positive’ residuals so that the reconstructed video is complete. Elsewhere the ‘negative’ residuals may be described as correction data, in that they adjust the base decoded video data to account for the modifications made to the ‘positive’ set of residuals.

Returning to FIG. 4, the residual splitter 404 is illustrated as a module within the enhancement decoder 402. It should be understood that this module may be a separate module to the enhancement decoder that receives the residuals generated by the enhancement decoding process or may be integrated within the enhancement decoder itself. That is, the enhancement decoding process itself may be modified to generate two sets of residuals directly, one representing positive values and one representing the negative values. Similarly, although a separate module, the separate module may be integrated within the enhancement decoder 402.

Again, note the negative residuals may not themselves be negative signed values but we use the label ‘negative’ to represent that the residuals are those which correspond to the negative components of the original set of residuals of the one or more layers of residuals.

The so-called negative residuals are fed to a subtraction module 405 where the negative residuals are subtracted from the base decoded video signal generated by the base decoder 401. A subtraction module is proposed here but it will be understood alternative methods of combining could be used depending on the nature of the negative residual values. For example, an adder could be used if the negative residuals are themselves signed.

In this example implementation, the negative residuals have the same dimensions as the base decoded video so that the subtraction is simple. Here in FIG. 4 this is indicated by indicating that the negative residuals are of low quality, i.e. of lower quality than the positive residuals designed as high quality. In this regard, what is meant is that the dimensions of the data are smaller, for example, the low quality negative residuals may have an HD dimension to match the base decoded video, while the positive residuals have a UHD dimension.

The subtraction module generates a modified version of the base decoded video which is fed to an upsampler 406. The modified base decoded video is upsampled and then combined with the positive residuals, here the combination is represented by an adder 407.

Referring to the example above, the negative residuals may be downsampled to an HD resolution and combined with an HD base decoded video signal. The upsampler 406 then upsamples the modified base to a UHD resolution to be combined with the UHD positive residuals.

By splitting the residuals in this way, operations can be divided between blocks that are able to handle the operations, overcoming their limitations.

It should be noted that by subtracting the negative residuals from the base decoder and then combining the modified base with the positive residuals, there is no longer a need for signed values to be used in operations. Since the negative residuals are subtracted before the positive residuals are combined, the negative residuals, i.e. the component of the residuals that are negative, can be unsigned values (or greater than or equal to zero).

By performing the subtraction at a lower quality, i.e. before the base decoder is upsampled, any bandwidth limitations of the implementing element can be obviated.

By separating the subtraction steps from the upsampling steps, the two aspects can be performed by different parts of the video decoder, each using the available functions of that part and factoring in the limitations. This is illustrated in the example of FIG. 4 where it is indicated that the subtraction 405 may be performed in a hardware block or the GPU of a video decoder, while the reconstruction stage, i.e. the upsampling 406 and the combination 407, may be performed at either a hardware block, a GPU or at the video output path such as a video shifter 408. In this way the UHD combination can be performed at a video shifter which is well suited to that purpose, but the subtraction (which the video shifter may not be able to perform) may be performed at a different element of the video decoder.

Preferably the reconstruction is performed at the video output path and the subtraction is performed at a hardware block or GPU.

This split conforms to the guiding principle that it would be beneficial to perform as many operations as possible in the video output path. By splitting the residuals, downscaling, and performing a subtraction prior to reconstruction, the hardware limitations can be overcome and the functions can be utilised to perform operations at which they excel.

Accordingly, the invention is realised through two complementary, yet both optional, features (a) separating (or generating) the residuals into positive and negative residual forms, and (b) the alteration of the LCEVC reconstruction operations to account for hardware limitations such as low bandwidth and the inability for the video pipeline to subtract and handle negative values.

FIG. 4 also illustrates the divide between the clear pipeline and the secure pipeline. That is, the operations of subtraction, upsampling and addition/combination may be performed in the secure portion of the video decoder, operating on secure memory, while the generation and separation of residuals may be performed in clear memory, i.e. normal general purpose memory, by the CPU or GPU.

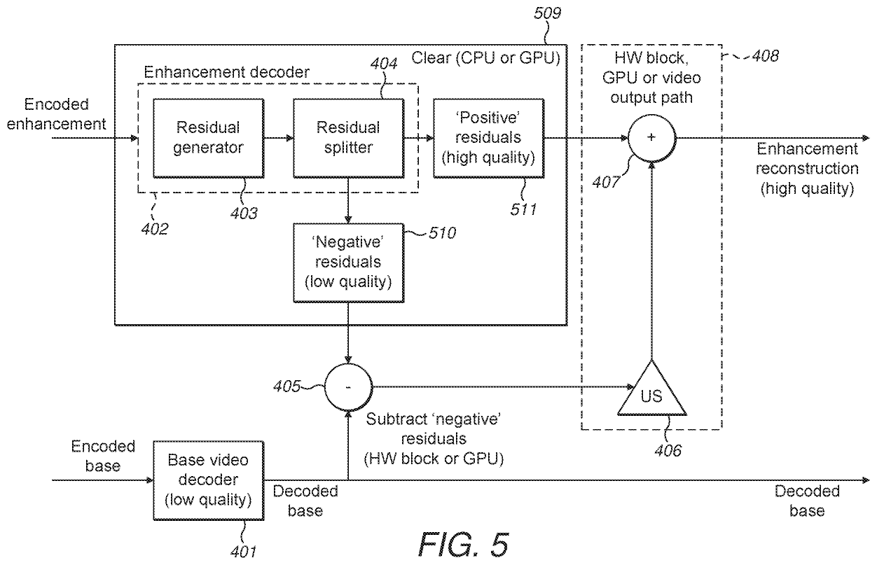

This is illustrated conceptually in FIG. 5 where block 509 indicates the functions or modules implemented in the clear pipeline by the CPU or GPU and block 408 indicates the functions performed on secure memory by the video output path (or optionally a hardware block or GPU) and the subtraction 405 performed on secure memory by a hardware block or GPU. FIG. 5 illustrates that the negative residuals 510 and the positive residual 511 may be stored in the clear pipeline, i.e. in normal general purpose memory.

In an alternative implementation of concepts described in this disclosure (not shown) the negative residuals may not be generated in low quality, i.e. not generated at a downsampled resolution, but instead may be of the same resolution as the output plane. In this example, the base decoded video may first be upsampled before the negative residuals are subtracted. The positive residuals can then be combined with the modified, upsampled, based decoded video. This concept may have utility depending on the particular limitations of the hardware blocks. For example, the implementing element may not be able to subtract and/or handle signed values but implementing elements may be able to handle the bandwidth of the high resolution operations. In short, for example, if the video shifter had the ability to subtract residuals then there could be a case where full resolution positive and negative planes are provided in the video shifter.

Similarly, there may be utility in performing an upsampling operation on the base decoded video, for example, using an already provided upsampling capability.

In the example where the negative and positive residuals have the same resolution, i.e. full, there may also be no need for the upsampling step. For example, the base decoded layer may have the same resolution as the enhancement layer with the enhancement layer providing corrections to errors introduced in the base coding, rather than providing an increase in resolution.

As a reminder, although we discuss secure memory here, that is only a requirement when playing back secure content and has no impact on the invention as it will work from any memory in the system that can be read.

We have described above how the residuals can be separated into a positive component and a negative component (positive and correction) and the operations to reconstruct the output video can be performed at different parts of the video decoder to realise the benefits of those parts and address their limitations. As described above, to realise these benefits the positive residuals correspond to a modified form of the generated residual data having only positive or zero values and the negative residuals serve to correct those modifications by adjusting the base decoded video signal prior to combination with the positive residuals. This enables operations to be performed using only unsigned (or positive values).

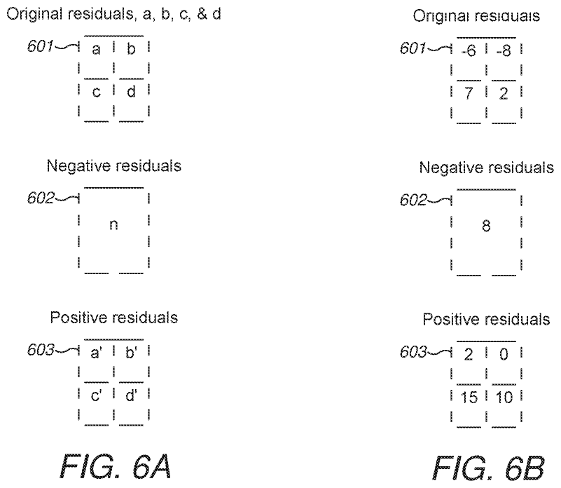

An example of the separation of these two sets of residuals will now be described in the context of FIGS. 6A and 6B.

For this example, we assume that the lower resolution (the base resolution) is half in both width and height of the higher resolution (final resolution). The input residuals would be generated at the final resolution. For each 2×2 square of pixels in the input residuals, we would need a 1×1 square in the negative residuals and a 2×2 square in the positive residuals.

The original residuals 601 are labelled a, b, c, d, that is, the residuals are labelled as four pixels of the 2×2 square. The negative residual 602 at the lower resolution, i.e. the 1×1 square corresponding to the 2×2 square at the higher resolution, is labelled n. The positive residuals 603 at the higher resolution are labelled a′, b′, c′, d′.

A simple algorithm that could be used to calculate the residuals is:

$$n = - f ( a , b , c , d ) ;$$

$${a}^{′} = a + n ;$$

$${b}^{′} = b + n ;$$

$${c}^{′} = c + n ;$$

$${d}^{′} = d + n .$$

In a further example:

n=−min(a,b,c,d).

This algorithm is illustrated in the worked example of FIG. 6B. In FIG. 6B, the original residuals are as follows: a=−6; b=−8; c=7; d=2.

Following the algorithm set out above, the negative residual is thus:

n=8=−min(−6,−8,7,2).

The positive residuals are therefore:

$${a}^{′} = 2 = - 6 + 8 ;$$

$${b}^{′} = 0 = - 8 + 8 ;$$

$${c}^{′} = 15 = 7 + 8 ;$$

$${d}^{′} = 10 = 2 + 8 .$$

As above, the negative residual is subtracted from the base decoded video which is then upsampled before combination with the positive residual so that the original residuals can be reconstructed accurately.

In this example rather than a true split of the positive and negative residuals, the negative component is subtracted from all the original residuals and so the positive residuals do not correspond completely to the positive residuals but are a modified form of the original residuals comprising only positive components. As can be seen, in this algorithm, all the originals are adjusted but other algorithms can be contemplated which remove any negative values but adjust the remaining original values in different ways. What is important is that the original values are separated into two sets of values, both having a combined effect of removing any negative signed values and the two sets can be combined with the base decoded video separately and compensate for the effects of the separation.

In the examples it has been contemplated that the negative residuals are combined with the base decoded video before upsampling.

In one example implementation there may be no compensation for any errors that the up sampling of the negative residuals may create. However, compensation can optionally be performed when the positive and negative generation taking that into account.

Furthermore, with an offset on the negative residuals and applying the correct upscaling filter, one can remove the errors. This may optionally result that the positive residuals are calculated from the upscaled negative residuals that will be applied, i.e.: positive residuals=signed residuals+upscaled negative residuals.

In a further alternative, it was described above that full resolution positive and negative residuals may be combined in the video shifter. The separation of the residuals may thus be thought of as more of a split as the resolutions of the planes will be the same.

Using the numbers of the worked examples, the original residuals may be (a, b, c, d,)=(−6,−8,7,2), the positive residuals may be (a′, b′, c′, d′)=(0,0,7,2) and the negative residuals at the higher resolution may be (a″, b″, c″, d″)=(6,8,0,0). In this way the negative residuals are unsigned values that can be subtracted from an upsampled base decoded video. That is, the residuals can be combined in two separate steps instead of one, factoring in that the hardware may not be able to handle signed values.

In a further optional implementation, the negative residuals may first be split into (a″, b″, c″, d″)=(6,8,0,0) before a subsequent downsampling step.

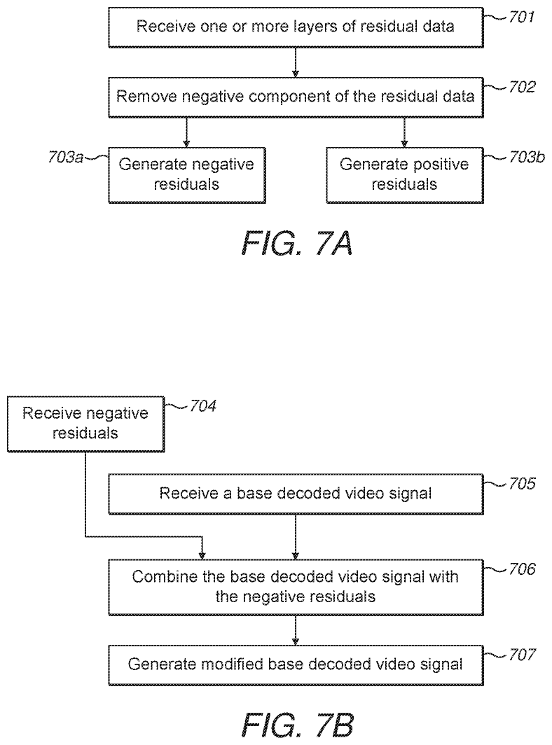

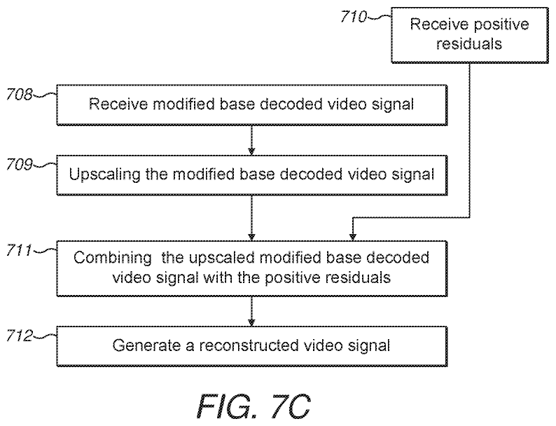

FIGS. 7A, 7B and 7C each represent flow diagrams of three example stages of the concepts proposed. As noted, each stage may be performed by the same or different modules of a video decoder. For convenience we will refer to these as separation, subtraction and reconstruction. In the separation stage of FIG. 7A, the module receives one or more layers of residual data (step 701) and then process the residual data (or optionally removes the negative component of the residual data, step 702), to generate one or more layers of negative residuals (step 703a) and one or more layers of positive residuals (step 703b). The positive residual data comprises only values greater than or equal to zero. The negative residual data is correction which combines with a base decoded video signal from a base decoding layer to modify the base decoded video signal such that, when the one or more layers of positive residual data are combined with the modified base decoded video signal to generate enhanced video data the enhanced video data includes the negative component of the residual data.

FIG. 7B illustrates the step of modifying the base decoded video to compensate for the adjustment of the original residuals to convert them into only positive values. The subtraction stage thus first receives the negative values (step 704). As noted, this may be from the separation stage, but optionally no separation stage may have been performed and the two sets of residuals may be generated directly by the enhancement decoding process. The subtraction stage also receives a base decoded video signal (step 705) from a base decoder. By base decoder, here we mean a decoder decoding video at a lower resolution and implementing base codec (for example Advanced Video Coding—AVC, also known as H.264, or High Efficiency Video Coding—HEVC, also known as H.265). The base decoded video signal is then combined with the negative residuals (step 706). Where the negative residuals are unsigned (or positive), the combination is a subtraction. Other combinations are contemplated. The subtraction stage outputs or generates a modified base decoded video signal (step 707).

At the reconstruction stage, illustrated by the flow chart of FIG. 7C, the modified base decoded video signal is received (step 708), for example from the separation stage. The modified base decoded video signal is upsampled or upscaled (step 709). The terms upsampling and upscaling are used interchangeably herein. The positive residuals are received (step 710) and combined with the upscaled modified base decoded video signal (step 711). Again, the positive residuals may be received from the separation stage but the separation stage may be optional and the positive residuals may be received directly from the enhancement decoder. After combination, the reconstruction stage may generate or output the reconstructed original input video (step 712) from the combination of the positive residuals and the upsampled base decoded video signal, modified by the negative residuals. The final step may comprise storing the output plane and outputting the output plane to an output module for sending to a display.

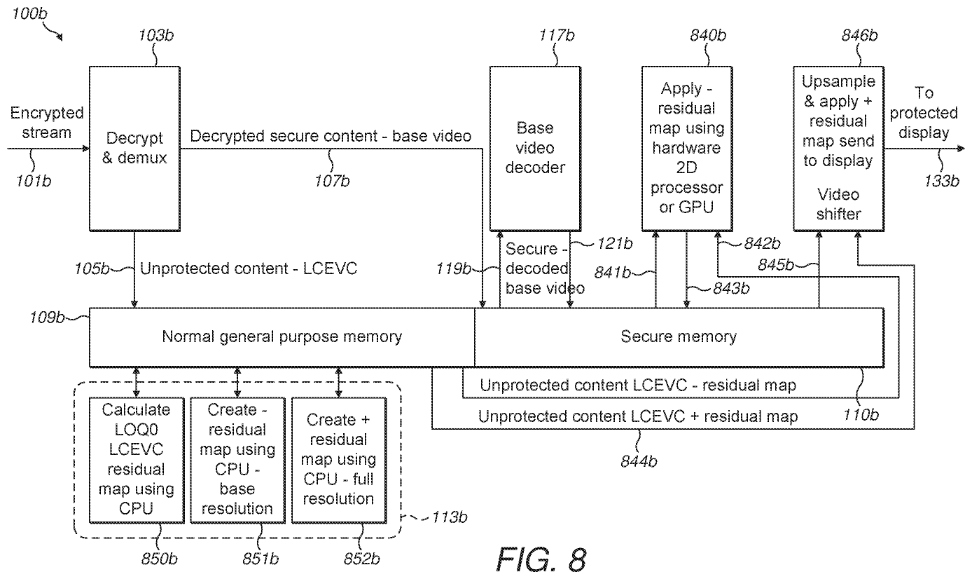

FIG. 8 illustrates the principles of the disclosure being implemented in a video decoding computer system 100b comprising normal general purpose memory and secure memory. The computing system comprises a receiving module 103b, a base decoding module 117b, an output module 846b, an enhancement layer decoding module 113b, an unsecure memory 109b, and a secure memory 110b. The computing system is in connection with a protected display (not illustrated).

The various components (i.e. the modules and the memory memory) are connected via a number of channels. The channels, also referred to as pipes, are communication channels that allow data to flow between the two components at each end of the channel. In general, channels connected to the secure memory 110c are secured channels. Channels connected to the unsecure memory 109c are unsecure channels. For ease of display, the channels are not explicit illustrated in the figures, rather, the data flow between various modules is shown.

The output module 846b has access to the secure memory 110b and to the unsecure memory 109b. The output module 131b is configured to read, from the secure memory 110b (via a secured channel), a modified decrypted decoded rendition of a base layer 845b of a video signal. The modified decrypted decoded rendition of the base layer 845b has a first resolution. The output module 846b is configured to read, from the unsecure memory 109b (e.g. via an unsecured channel), a decoded rendition of a positive residual layer 844b of the video signal, labelled in FIG. 8 as the unprotected content LCEVC positive residual map. The decoded rendition of the positive residual layer 844b has a second resolution. In this illustrated embodiment, the second resolution is higher than the first resolution, (however, this is not essential, the second resolution may be the same as the first resolution, in which case, upsampling may not be performed on the decrypted decoded rendition of the base layer). The output module 846b is configured to generate an upsampled modified decrypted decoded rendition of the modified base layer of the video signal by upsampling the modified decrypted decoded rendition of the base layer 845b such that the upsampled modified decrypted decoded rendition of the base layer 845b has the second resolution. The output module 846b is configured to apply the decoded rendition of the positive residual layer 844b to the upsampled modified decrypted decoded rendition of the base layer to generate an output plane. The output module 846b is configured to output the output plane 133b, via a secured channel, to a protected display (not illustrated). In the computing system, the output module may be a video shifter.

The secure memory 110b is configured to receive, from the receiving module 103b, a decrypted encoded rendition of the base layer 107b of the video signal. The secure memory 110b is configured to output 119b the decrypted encoded rendition of the base layer to the base decoding module 117b. The secure memory 110b is configured to receive, from the base decoding module 117b, the decrypted decoded rendition of the base layer 121b of the video signal generated by the base decoding module 117b. The secure memory 110b is configured to store the decrypted decoded rendition of the base layer 121b.

The secure memory 110b is configured to output (via a secure channel), to the subtraction module 840b, the decrypted decoded rendition of the base layer of the video signal 841b.

The subtraction module 840b has access to the secure memory 110b and to the unsecure memory 109b. The subtraction module 840b is configured to read, from the secure memory 110b (via a secured channel), a decrypted decoded rendition of a base layer 841b of a video signal. The decrypted decoded rendition of the base layer 841b has a first resolution. The subtraction module 840b is configured to read, from the unsecure memory 109b (via an unsecured channel), a decoded rendition a negative residual layer 842b, labelled in FIG. 8 as unprotected content LCEVC negative residual map. The decoded rendition of the negative residual layer 842b has a first resolution. In this illustrated embodiment, the second resolution is higher than the first resolution, (however, this is not essential, the second resolution may be the same as the first resolution, in which case, upsampling may not be performed on the modified decrypted decoded rendition of the base layer). The subtraction module 840b is configured to apply the negative residual map to the decrypted decoded rendition of the base layer 841b to generate the modified decrypted decoded rendition of the base layer 843b and output, via a secured channel, to the secure memory 110b for storage in the secure memory 110b. The subtraction module 840b may be a hardware scaling and compositing block as typically found within a Video decoder SoC.

Alternatively, the subtraction module 840b may be a GPU operating in the secure memory.

The computing system 100b comprises the unsecure memory 109b. The unsecure memory 109b is configured to receive, from the receiving module 103b (via an unsecured channel), and store an encoded rendition of the enhancement layer 105b of the video signal. The unsecure memory 109b is configured to output the encoded rendition of the enhancement layer to the enhancement decoding module 113b configured to generate the decoded rendition of the enhancement layer by decoding the encoded rendition of the enhancement layer. The unsecure memory 109b is configured to receive, from the unsecure decoding module 113b, and store the decoded rendition of the enhancement layer. The unsecure memory 109b is configured to output the decoded rendition of the enhancement layer to the enhancement decoding module 113b configured to generate the negative residual layer at the first resolution. The unsecure memory 109b is configured to receive, from the unsecure decoding module 113b, and store the negative residual layer. The unsecure memory 109b is configured to output the decoded rendition of the enhancement layer to the enhancement decoding module 113b configured to generate the positive residual layer at the second resolution. The unsecure memory 109b is configured to receive, from the unsecure decoding module 113b, and store the positive residual layer.

The generation of the decoded rendition of the enhancement layer, the generation of the negative residual layer and the generation of the positive residual layer may be performed in multiple stages, 850b, 851b, 852b, or a single stage, 113b. In the single stage, the unsecured memory 109b outputs the encoded rendition of the enhancement layer 105b and stores the negative residual map and the positive residual map.

The computing system 100b comprises the receiving module 103b. The receiving module 103b is configured to receive, as a single stream, the video signal 101b. The video signal comprises the encrypted encoded rendition of the base layer 107b and the encoded rendition of the enhancement layer 105b. The receiving module 103b is configured to separate the video signal into: the encrypted encoded rendition of the base layer and the encoded rendition of the enhancement layer. The receiving module 103b is configured to decrypt the encrypted encoded rendition of the base layer. The receiving module 103b is configured to output the encoded rendition of the enhancement layer 105b to the unsecure memory 109b. The receiving module 103b is configured to output the decrypted encoded rendition of the base layer 107b to the secure memory 110b.

The received encoded rendition of the enhancement layer may be received by the receiving module 103b as an encrypted version of the encoded rendition of the enhancement layer. In such an example, the receiving module 103b is configured to, before outputting the encoded rendition of the enhancement layer, decrypt the encrypted version of the encoded rendition of the enhancement layer to obtain the encoded rendition of the enhancement layer 105b.

The computing system 100b comprises the base decoding module 117b. The base decoding module 117b is configured to receive the decrypted encoded rendition of the base layer 119b of the video signal. The base decoding module 117b is configured to decode the decrypted encoded rendition of the base layer to generate a decrypted decoded rendition of the base layer. The base decoding module 117b is configured to output, to the secure memory 110b for storage, the decrypted decoded rendition of the base layer 121b.

Predicted residuals, e.g. using a predicted average based on lower resolution data, as described in WO 2013/171173 (which is incorporated by reference) and as may be applied (such as in section 8.7.5 of LCEVC standard) as part of a modified upsampling procedure as described in WO/2020/188242 (incorporated by reference) may be processed by the output module 131b. WO/2020/188242 is particularly directed to section 8.7.5 of LCEVC, as the predicted averages are applied via what is referred to as “modified upsampling”. In general, WO 2013/171173 describes the predicted average being computed/reconstructed at a pre-inverse-transformation stage (i.e. in transformed coefficient space) but the modified upsampling in WO 2020/188242 moves the application of the predicted average modifier outside of the pre-inverse-transformation stage and applies it during upsampling (in a post-inverse transformation or reconstructed image space), this is possible as the transforms are (e.g. simple) linear operations so the application of them can be moved within the processing pipeline. Therefore, the output module 131b may be configured to: generate the predicted residuals (in line with the methods described in WO 2020/188242); and apply the predicted residuals (generated by the modified upsampling) to the upsampled decrypted decoded rendition of the base layer (in addition to applying the modified decoded rendition of the enhancement layer 115b) to generate the output plane. In general, the output module 131b generates the predicted residuals by determining a difference between: an average of a 2 by 2 block of the upsampled decrypted decoded rendition of the base layer; and a value of a corresponding pixel of the (i.e. not upsampled) decrypted decoded rendition of the base layer.

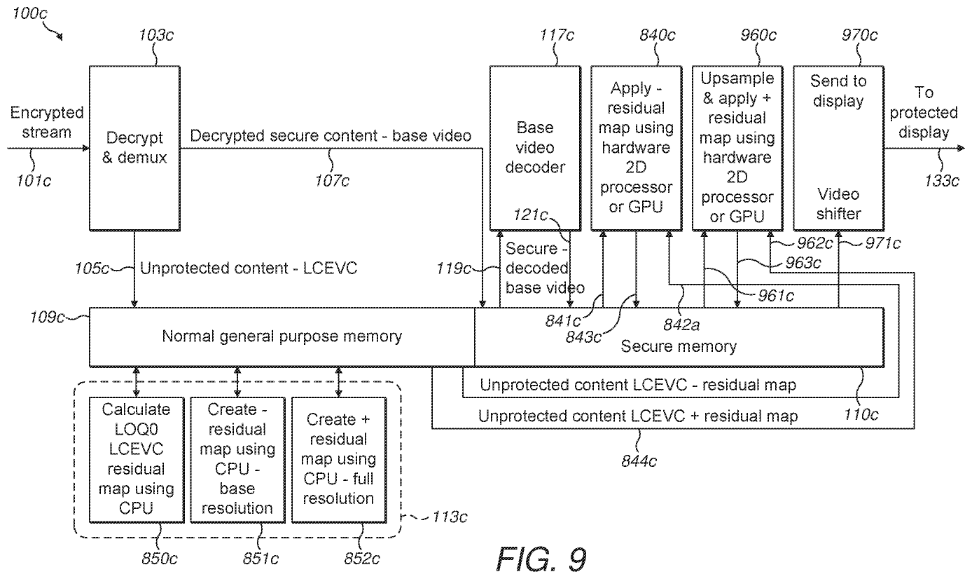

The example of FIG. 9 corresponds largely to the example of FIG. 8. This includes the flow of data throughout the computing system 100b corresponding to that of computing system 100c. The reference numerals of FIG. 9 correspond to that of FIG. 9 to illustrate the corresponding nature of the computing system 100b to that of the computing system 100c. A difference between the computing system 100b and the computing system 100c is a reconstruction module 960c which is configured to perform the steps of upsample and combine with the positive residual map to provide the enhancement overlay.

That is, the reconstruction module 960c has access to the secure memory 110c and to the unsecure memory 109c. The module 960c is configured to read, from the secure memory 110c (via a secured channel), a modified decrypted decoded rendition of a base layer 961c of a video signal. The modified decrypted decoded rendition of the base layer 125c has a first resolution. The module 960c is configured to read, from the unsecure memory 109c (via an unsecured channel), a decoded rendition of a positive residual layer 962c of the video signal. The decoded rendition of the positive residual layer has a second resolution. In this illustrated embodiment, the second resolution is higher than the first resolution (however, this is not essential, the second resolution may be the same as the first resolution, in which case, upsampling may not be performed). The reconstruction module 960c is configured to generate an upsampled modified decrypted decoded rendition of the base layer of the video signal by upsampling the modified decrypted decoded rendition of the base layer 961c such that the upsampled modified decrypted decoded rendition of the base layer 961c has the second resolution. The reconstruction module 960c is configured to apply the decoded rendition of the positive residual layer 962c to the upsampled modified decrypted decoded rendition of the base layer to generate an output plane. The module 960c is configured to output the output plane 963c, via a secured channel, to the secure memory 110c for storage in the secure memory 110c.

In the embodiment illustrated in FIG. 9, the reconstruction module 960c may be a hardware scaling and compositing block as typically found within a Video decoder SoC. The reconstruction modules 960c may be a hardware 2D processor or a GPU operating on secure memory.

The secure memory 110c is configured to output (via a secure channel), to the reconstruction module 960c, the modified decrypted decoded rendition of the base layer of the video signal 961c. The secure memory 110c is configured to receive, from the module 960c, the output plane 963c generated by the reconstruction module 960c. The secure memory 110c is configured to store the output plane 963c. The secure memory 110c is configured to output (971c) the output plane 963c to the output module 970c.

In FIG. 9, the computing system 100c comprise the output module 970c, which may be a video shifter. The output module 970c is configured to receive, from the secure memory 110c, the output plane 971c. The output module 970c is configured to output 133c the output plane to a protected display (not illustrated).

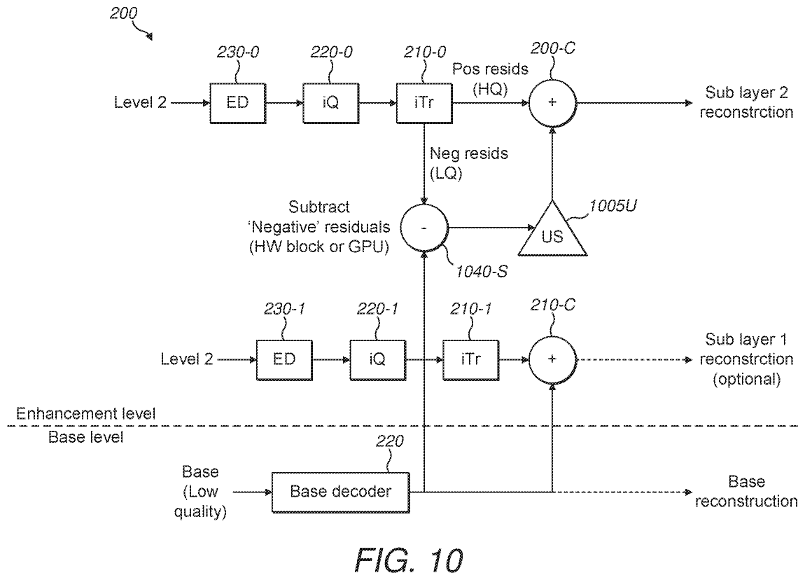

FIG. 10 illustrates a block diagram of an enhancement decoder incorporating the steps of the separation and subtraction stages described elsewhere in this disclosure, as well as the broad general steps of an enhancement decoder. As described elsewhere, the residuals may be generated in separated form as illustrated here, rather than separated from a set of residuals created by an enhancement decoder.

The encoded base stream and one or more enhancement streams are received at the decoder 200.

The encoded base stream is decoded at base decoder 220 in order to produce a base reconstruction of the input signal 10 received at encoder. This base reconstruction may be used in practice to provide a viewable rendition of the signal at the lower quality level. However, this base reconstruction signal also provides a base for a higher quality rendition of the input signal.

FIG. 10 illustrates both sub layer 1 reconstruction and sub layer 2 reconstruction. In the illustrated enhancement decoder, the reconstruction of sub layer 1 is optional.

At sub layer 1, in order to reconstruct the level 1 video signal, the decoded base stream is provided to a processing block. The processing block also receives an encoded level 1 stream and reverses any encoding, quantization and transforming that has been applied by the encoder. The processing block comprises an entropy decoding process 230-1, an inverse quantization process 220-1, and an inverse transform process 210-1. Optionally, only one or more of these steps may be performed depending on the operations carried out at corresponding block at the encoder. By performing these corresponding steps, a decoded level 1 stream comprising the first set of residuals is made available at the decoder 200. The first set of residuals is combined with the decoded base stream from base decoder 220 (i.e. a summing operation 210-C is performed on a decoded base stream and the decoded first set of residuals to generate a reconstruction of the downsampled version of the input video—i.e. the reconstructed base codec video).

Additionally, and optionally in parallel, the encoded level 2 stream is processed in order to produce a decoded further set of residuals. Similarly to above level 1 processing block, the level 2 processing block comprises an entropy decoding process 230-2, an inverse quantization process 220-2 and an inverse transform process 210-2. These operations will correspond to those performed at block in the encoder, and one or more of these steps may be omitted as necessary. As illustrated in FIG. 10, the output of the level 2 processing block is a set of ‘positive’ residuals and a set of ‘negative’ residuals, optionally as illustrated, in a lower resolution.

The ‘negative’ residuals are subtracted from the decoded base stream from base decoder 220 at operation 1040-S to output a modified decoded base stream. The modified decoded base stream is upsampled at upsampler 1005U and summed with the positive residuals at the higher resolution at operation 200-C in order to create a level 2 reconstruction of the input signal 10.

As noted above, the enhancement stream may comprise two streams, namely the encoded level 1 stream (a first level of enhancement) and the encoded level 2 stream (a second level of enhancement). The encoded level 1 stream provides a set of correction data which can be combined with a decoded version of the base stream to generate a corrected picture.

While FIG. 10 shows the positive and negative residuals being separated and applied in the sub layer 2 reconstruction, it is possible to implement the concepts described herein in the sub layer 1 reconstruction should it be implemented as well. For example, the residuals could be included by generating the positive and negative residuals for the sub layer and then adding and subtracting them before the application of the negative residuals.

An architecture for implementing the above concepts may comprise three main components.

A first component may be a user space application. Its purpose may be to parse the input transport stream (e.g. MPEG2), extract the base video and LCEVC stream (e.g. SEI NALU and dual track multiplexing). The function of the application is to: configure the hardware base video decoders and pass the base video for decoding; decode the LCEVC stream using the DPI to create a pair of positive and negative residual planes; and the base video decode and the negative residuals are sent to the LCEVC Device Driver.

A second component of the architecture may be an LCEVC Device Driver. Its purpose is to manage buffers of LCEVC residuals, configure a graphics accelerator unit, and add dithering. The graphics accelerator unit may be a standalone 2D graphic acceleration unit with image scaling, rotation, flipping, alpha blending and other functions. The function of the LCEVC Device Driver may be: the output of the base decoder is composed (through subtraction) with the negative residuals using graphics accelerator unit; and, the output of the graphics accelerator unit and the positive residuals are then sent to a display driver.

A third component of the architecture may be a display driver. Its purpose is that modified video device drivers perform upscaling and composition using the a Blender and a set of hardware compositors. The Blender may be used to compose multiple video planes into a single output. The function of the display driver is that: the output of the graphics accelerator unit is upscaled, then composed using the Blender (through addition with a pre-computed alpha) with the full resolution positive residuals and a randomly generated dither mask placed on an On-Screen Display (OSD) plane; and, the output of the Blender is sent to the Display Driver.

In an implementation, the base and enhanced video will be held in hardware protected buffers throughout this process (i.e. a secure video path).

The implementation varies slightly across different SoC variants. Some variants of the SoC have more features allowing extra capabilities such as negative residuals at enhanced resolution, a second upscale, colour management or image sharpening. Fundamentally the architecture remains the same, i.e.: the graphics accelerator unit is used for negative residuals; and, the blender is used for positive residuals

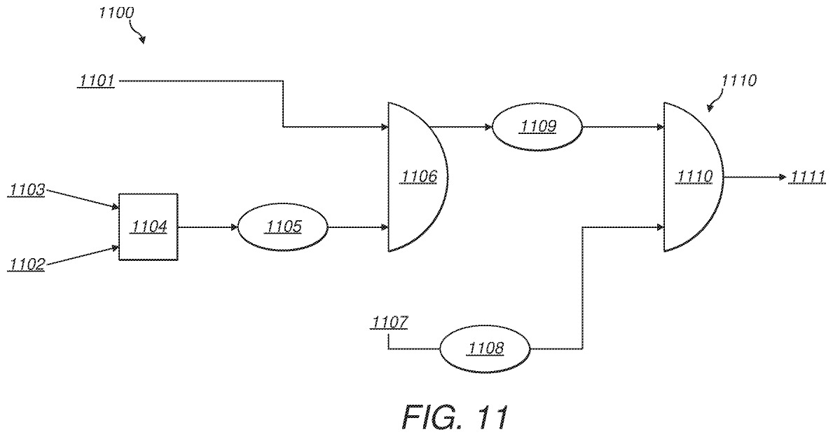

In accordance with a further example of how the concept of two sets of residuals may be implemented, it is contemplated that further operations may be provided on either or both of the sets of residuals, i.e. the positive or negative residuals, prior to combination to improve the efficiency or effectiveness of the final results. An example of this is shown in FIGS. 11 to 13 which illustrate a simplification of a blending diagram illustrating a possible data flow for applying LCEVC enhancement to the video.

In the description below, we indicate exemplary input video planes with (vd1) and (vd2) and exemplary graphics planes with (osd1). It is noted that a desirable method for enhancing base video enhancing the base video with LCEVC is: perform a ×2 upscale of the base video using specified scaler coefficients (kernel); add Predictive Averages, i.e. the difference between a pixel value in the base video and the average of 4 pixels in the corresponding 2×2 upscaled block; apply a plane of signed offsets to the result; and, dither the output by adding a plane of signed random values. Preferably these steps are performed in hardware. Due to the nature of the hardware blocks and their connections in SoC, and limitations of memory bandwidth a compromise solution has been implemented, as described elsewhere in this document: subtract negative residuals from the base video at base video resolution; perform a×2 upscale of (base video−negative residuals) using specified scaler coefficients; and, use blending to add full resolution positive residuals to the upscaled result. For dithering, use blending to add a plane of positive random values—scaled so that they don't exceed the specified dither strength.

As illustrated in the Figures, dithering may be applied at a lower resolution, which is then combined with the video signal to produce the final output. This approach leads to surprisingly good visual quality. In other words, the dithering is applied at a separate plane and at lower resolution than the output resolution. Moreover, the dithering may be applied to each of the YUV planes, whereas typically dithering may be applied to only one.

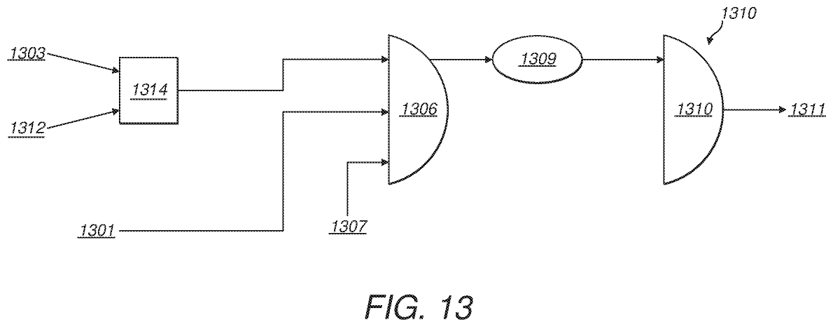

Consistent with the concepts described in this disclosure, two signals may be output from the enhancement decoding function and combined with the base decoded video signal. Thus, the inputs to the video display path are a set of ‘positive’ residuals as described elsewhere herein, a set of ‘negative’ residuals as described elsewhere herein (typically at a lower resolution than the ‘positive’ residuals), and, a base decoded video signal (typically at a lower resolution than the ‘positive’ residuals and typically at the same resolution as the ‘negative’ residuals, but not always as explained in the context of FIG. 13).

As described elsewhere above, we use the terms positive and negative in this context as labels to describe the functionality of the two sets of the residuals which are together combined to recreate the effect of intended residuals on the base decoded video signal. The negative residuals are not negative, per se, but instead modify the base decoded residuals to recreate the effect of the negative part of the residuals layer.

In examples the positive residuals may be at a 4K resolution, the base decoded video signal and the negative residuals may be at a 1080P resolution (or 4K in FIG. 13). It will be understood that these are exemplary resolutions only.

Consistent with the above processing paths, the negative residuals are subtracted from the base decoded video signal. This may be performed at a graphics accelerator block, such as the Amlogic GE2D 2D graphics accelerator unit. The output of the subtraction may be an 8-bit modified form of the base decoded video signal. In this example, after subtraction, the modified base decoded signal is upscaled. Here, the upscaling is to match the 4K resolution of the original video and the 4K resolution of the positive residuals. It will be understood that the scaling may be dependent on the resolutions of the signals and is not limiting. In this example, the upscaled modified base decoded video signal is then combined with the positive residuals to output an LCEVC enhanced video at the pre-blend stage. This enables further hardware enhancements such as colour management, sharpening, etc. to be enabled if desired.

In a first example shown in FIG. 11, there is shown an exemplary path 1100. 1080P negative residuals 1102 are subtracted by a subtract module 1104 from a 1080P base video signal 1103. This output (typically 8 bit) is then scaled 1105, for example a ×2 upscale to 4K. This output (vd2) may then be combined with 4K positive residuals 1101 (vd1) at a pre-blend stage 1106.

As shown in FIG. 11, a dither plane 1107, such as a 960×540 dither plane, may be scaled and applied at a post-blend stage 1110 to a scaled version of the LCEVC enhancement output itself scaled for display resolution. That is, the enhanced video output from the pre-blend stage 1106 is scaled by a scale module 1109 to a display resolution (vd1) which is input to a post-blend stage 1110 along with a scaled dither plane, also at the display Resolution (osd2). The video may then be output for display 1111.

Put another way, the LCEVC enhancement output, i.e. the output of the pre-blend and the enhanced video data, may be scaled to a display resolution such as a 4:4:4 display resolution in which Luma and Chroma have the same spatial resolution (other display resolutions such as 4:2:2 or 4:2:0 are of course contemplated). A dither plane may also be scaled to a display resolution, in this example 4:2:2. The dither plane and the scaled enhanced video signal are then combined at a post-blend stage to generate the video for display.

As noted above, applying dithering in this way, i.e. the enhanced video is output at the pre-blend stage and then dithering is applied at a post-blend stage yields surprisingly good display quality. Moreover, arranging the video display path in this way allows for display to be in any resolution.

The dither plane is input, i.e. applied, at a lower resolution before scaling.

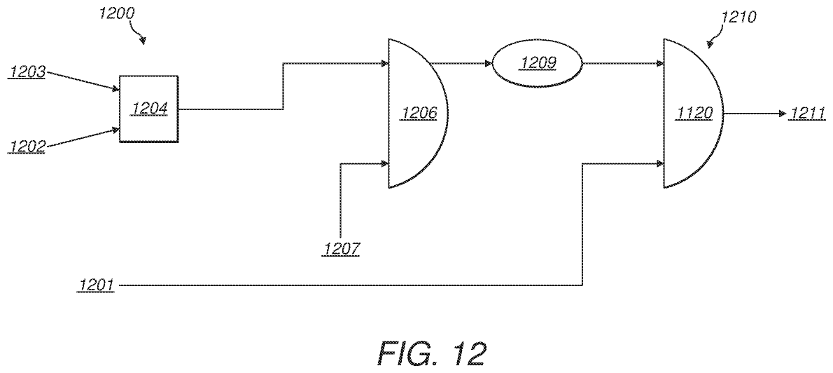

An alternative example is shown in FIG. 12. In the illustration of FIG. 12, the dither plane is combined at the Pre-Blend stage before the 4K positive residuals are later combined.

As in examples described above, 1080P negative residuals 1202 are subtracted by a subtract module 1204 from a 1080P base video 1203. This output (typically 8 bit) is then passed (vd1) to the pre-blend stage 1206 without first being scaled, in a different arrangement to that of FIG. 11. A dither plane (in this example a 1080p dither plane at a 4:2:2 resolution) 1107 is also passed (osd2) to the pre-blend stage 1206.

The output of the pre-blend stage is then scaled 1209, for example, upscaled to a display resolution, which is typically ×2 is the display resolution is 4k. The scaled output, for example at a 4:4:4 display resolution is then combined (vd1) with 4K positive residuals 1201 (vd2) at a post-blend stage 1210 for output to display 1211.

In the example of FIG. 12, typically the display resolution may match the video content resolution, as there is nothing else to scale between the two.

A third illustrative example of a video display path 1300 is shown in FIG. 13. In this example, the same 2D accelerator unit performs the upscaling and subtraction, and the dither plane is then combined at the pre-blend stage.

In the example of FIG. 13, the negative residuals 1312 are at 4K rather than 1080P, as in FIGS. 11 and 12, i.e. they are at the same resolution as the positive residuals—the output resolution. Thus in this example the 1080P base video 1303 is upscaled (typically ×2 upscale) and then the 4K negative residuals are subtracted from the 4K scaled base video. In this example the upscale and subtraction are performed by the same module 1314. Typically, this output is 8 bit and is then passed to the pre-blend stage 1306.

The pre-blend stage 1306 combines the 4K positive residuals 1301 (vd2) with the modified 4K scaled base video (vd2) and the dither plane 1307 (osd2). The dither plane in this example may be 1080P at a 4:2:2 display resolution, although other display resolutions are of course possible.

The output of the pre-blend stage 1306 is then scaled 1309 to a display resolution before being passed to a post-blend stage 1310 and then output for display 1311.

The compromises with the example of FIG. 13 are that while the accelerator unit performing the upscale and subtraction may be slow and a significant amount of memory bandwidth is required, the negative residuals are at the same resolution as the positives making it easier to split the plane of signed residuals output from the decoder.

In summary, in the video paths above, positive dithering is applied at lower resolution, upscaled, then added to the final output. In other words, the dithering is applied at a separate plane and at lower resolution than the output resolution. Moreover, the dithering is applied to each of the YUV planes, whereas often dithering will be applied to just one.

Generally, any of the functionality described in this text or illustrated in the figures can be implemented using software, firmware (e.g., fixed logic circuitry), programmable or nonprogrammable hardware, or a combination of these implementations. The terms “component” or “function” as used herein generally represents software, firmware, hardware or a combination of these. For instance, in the case of a software implementation, the terms “component” or “function” may refer to program code that performs specified tasks when executed on a processing device or devices. The illustrated separation of components and functions into distinct units may reflect any actual or conceptual physical grouping and allocation of such software and/or hardware and tasks.

1-29. (canceled)

30. A module for use in a video decoder, configured to:
receive one or more layers of residual data from an enhancement decoding layer, the one or more layers of residual data being generated based on a comparison of data derived from a decoded video signal and data derived from an original input video signal;
process the one or more layers of residual data to generate a set of modified residuals comprising one or more layers of positive residual data, wherein the positive residual data comprises only values greater than or equal to zero; and
generate one or more layers of correction data, the correction data being configured to combine with a base decoded video signal from a base decoding layer to modify the base decoded video signal such that, when the one or more layers of positive residual data are combined with the modified base decoded video signal to generate enhanced video data, the enhanced video data corresponds to a combination of the base decoded video signal with the one or more layers of residual data from the enhancement decoding layer.

31. The module of claim 30, wherein dimensions of the one or more layers of correction data correspond to dimensions of a downsampled version of the one or more layers of residual data.

32. The module of claim 30, wherein the positive residual data is generated using the correction data and the one or more layers of residual data.

33. The module of claim 30, wherein elements of the correction data are calculated as a function of a plurality of elements of the residual data.

34. The module of claim 33, wherein elements of the correction data are calculated according to:
n=−f(a,b,c,d);
where n is an element of the correction data and a, b, c, d are elements of the residual data, wherein elements of the positive residual data a′, b′, c′, d′ are calculated according to:
$${a}^{′} = a + n ;$$
$${b}^{′} = b + n ;$$
$${c}^{′} = c + n ;$$
$${d}^{′} = d + n ;$$
and wherein elements a′, b′, c′, d′ of the positive residual data each correspond to elements a, b, c, d of the residual data respectively.

35. The module of claim 30, wherein the module is a module in a CPU or GPU of a video decoder chipset.

36. A module for use in a video decoder, configured to:
receive a base decoded video signal from a base decoding layer;
receive one or more layers of correction data; and
combine the correction data with the base decoded video signal to modify the base decoded video signal such that, when one or more layers of positive residual data are combined with the modified base decoded video signal to generate enhanced video data, the enhanced data corresponds to a combination of the base decoded video signal with one or more layers of residual data from the enhancement decoding layer,
wherein the positive residual data comprises only values greater than or equal to zero and is based on one or more layers of residual data from an enhancement decoding layer, the one or more layers of residual data being generated based on a comparison of data derived from a decoded video signal and data derived from an original input video signal.

37. The module of claim 36, wherein the module is a subtraction module configured to subtract the one or more layers of correction data from the base decoded video signal to generate the modified decoded video signal.

38. The module of claim 37, wherein the module is a module in a hardware block or GPU of a video decoder chipset.

39. The module of claim 37, wherein the subtraction module is comprised in a secure region of a video decoder chipset and operations are performed on secure memory of the video decoder chipset.

40. The module of claim 36, wherein the module is further configured to apply a dither plane, wherein the dither plane is input at a first resolution, the first resolution being lower than a resolution of the enhanced video data.

41. A method for use in a video decoder, comprising:
receiving one or more layers of residual data from an enhancement decoding layer, the one or more layers of residual data being generated based on a comparison of data derived from a decoded video signal and data derived from an original input video signal;
processing the one or more layers of residual data to generate a set of modified residuals comprising one or more layers of positive residual data, wherein the positive residual data comprises only values greater than or equal to zero; and
generating one or more layers of correction data, the correction data being configured to combine with a base decoded video signal from a base decoding layer to modify the decoded video signal such that, when the one or more layers of positive residual data are combined with the modified base decoded video signal to generate enhanced video data, the enhanced video data corresponds to a combination of the base decoded video signal with the one or more layers of residual data from the enhancement decoding layer.

42. The method of claim 41, wherein the positive residual data is generated using the correction data and the one or more layers of residual data and/or wherein elements of the correction data are calculated as a function of a plurality of elements of the residual data.

43. The method of claim 42, wherein the positive residual data is generated using the correction data and the one or more layers of residual data, preferably wherein elements of the correction data are calculated according to:
n=f(a,b,c,d);
where n is an element of the correction data and a, b, c, d are elements of the residual data, wherein elements of the positive residual data a′, b′, c′, d′ are calculated according to:
$${a}^{′} = a + n ;$$
$$b = b + n ;$$
$${c}^{′} = c + n ;$$
$${d}^{′} = d + n ;$$
and wherein elements a′, b′, c′, d′ of the positive residual data each correspond to elements a, b, c, d of the residual data respectively.

44. A method for use in a video decoder, comprising:
receiving a base decoded video signal from a base decoding layer;
receiving one or more layers of correction data; and
combining the correction data with the base decoded video signal to modify the decoded video signal such that, when one or more layers of positive residual data are combined with the modified base decoded video signal to generate enhanced video data, the enhanced video data the enhanced data corresponds to a combination of the base decoded video signal with one or more layers of residual data from the enhancement decoding layer,
wherein the positive residual data comprises only values greater than or equal to zero and is based on one or more layers of residual data from an enhancement decoding layer, the one or more layers of residual data being generated based on a comparison of data derived from a decoded video signal and data derived from an original input video signal.

45. The method of claim 44, wherein the step of combining comprises subtracting the one or more layers of correction data from the base decoded video signal to generate the modified decoded video signal.

46. The method of claim 44, further comprising:
upsampling the modified base decoded video signal; and, combining the upsampled modified base decoded video signal with the one or more layers of positive residual data to generate a decoded reconstruction of an original input video signal, preferably the step of combining the upsampled modified base decoded video signal with the one or more layers of positive residual data is performed by a hardware block, GPU or video output path of a video decoder chipset.

47. The method of claim 44, further comprising applying a dither plane, wherein the dither plane is input at a first resolution, the first resolution being lower than a resolution of the enhanced video data.
